(19) United States
(12) Patent Application Publication
(10) Pub. No.: US 2005/0094527 A1
(43) Pub. Date: May 5, 2005

(54) Information recording method and optical disk apparatus

(76) Inventors: Manabu Katsuki, Yokohama (JP); Norimoto Ichikawa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/937,351

(22) Filed: Sep. 10, 2004

(30) Foreign Application Priority Data
Sep. 12, 2003 (JP) 2003-320598

(51) Int. Cl. G11B 7/00; G11B 3/00

(52) U.S. Cl. 369/59.11; 369/116

(57) ABSTRACT

A method and apparatus for recording information which presume a recording state from reflected light during recording to achieve a stable recording quality. When recording information on an optical disk by irradiating laser light with a specified record power (Pw) to form a train of record pits, the recording is performed while forcing a value (CF) of B/Pw² to be kept substantially constant, where B is the value obtainable by sample-hold of a reflection light amount upon irradiation of the laser light with the specified record power (Pw). Performing the recording in this way makes it possible to realize the recording quality with increased stability. In addition, upon alteration of a tilt angle, arithmetic processing is redone to thereby achieve the stability-enhanced recording quality.

### INCORPORATION BY REFERENCE

The present application claims priority from Japanese application JP2003-320598 filed on Sep. 12, 2003, the content of which is hereby incorporated by reference into this application.

### BACKGROUND OF THE INVENTION

1. Field of the Invention

The present invention relates to record/playback apparatus for recording data on a recordable optical disk and for reproducing data therefrom.

2. Description of the Related Art

Presently, information-recordable optical disks include those called the “CD−R,”“CD−RW,”“DVD−R,”“DVD−RW,”“DVD+R,”“DVD+RW,”“DVD−RAM” and others, which are commercially available in the marketplace. Certain ones of these optical disks, i.e., CD−RW, DVD−RW, DVD+RW and DVD−RAM, are rewritable optical disks capable of rewriting data for a plurality of times. The others of them, i.e., CD−R, DVD−R and DVD+R, are write-once/read-many (“WORM”) disks that are recordable only one time with respect to the same surface portion, because these disks employ a dye film for a recording film.

In spite of such limited recordability of the WORM disks as to the lack of an ability to rewrite data at the same disk surface portion, a large number of WORM disks are widely used in various situations. One reason for this is that they are easy in mass-production. Another reason is that they are low in per-disk price. However, due to the fact that recording is done at a dye film, formation of record pits significantly depends upon the recording power of a laser beam used. By taking account of this fact along with the write-once nature stated above, an enhanced stability is required for control of the record power. Until today, various approaches to achieving the stability-enhanced recording control have been proposed, one of which is disclosed, for example, in JP-A-7-57268.

### SUMMARY OF THE INVENTION

Most WORM disks using dye films accompany with a risk as to occurrence of dye-film deposition irregularities. Due to this, the recording sensitivity tends to differ with respect to radial directions of such disks. Accordingly, in order to perform well-stabilized recording over the entire disk surface, there is a need to monitor the recording state during recording and to re-set the record power at an optimal level, as required.

In JP-A-7-57268, an attempt is made to realize stability-increased recording by controlling the record power in a way such that the ratio of a peak value of reflected light upon formation of a record pit versus a stable value of reflection light appearing after the peak value has a predetermined value.

In recent years, DVD−R and DVD+R disks experience high-speed recording such as eight-time or “×8” speeds (data rate is beyond 200 megabits per second (Mbps)). This poses problems which follow. FIG. 10A shows a laser light waveform, which is a laser output during high-speed recording, whereas FIG. 10B shows a reflection light waveform (solid line) observable by an optical disk apparatus and the actual or “real” reflection light waveform (broken line).

To obtain the reflection light waveform, an amplifier is provided in the optical disk apparatus. This amplifier has a limit of response speed, known as the “through rate” in the art. Due to the presence of such through-rate limitation, it is impossible to sufficiently keep track of rising edges of the real reflection light during high-speed recording sessions. As a consequence, there is a problem as to the inability to accurately obtain the real peak value of the reflection light waveform.

For this reason, it has heretofore been difficult to monitor any accurate recording state during high-speed recording. Thus a different monitoring methodology has been required. Note that it may be possible to monitor the recording state by use of a recording power value in place of the peak value of reflected light waveform. Unfortunately, this approach also has the problem that no good results are obtainable.

The above-noted problems can be solved or alleviated by using an information recording method for recording information by irradiating laser light onto an optical disk at a predetermined recording power Pw to form a record pit or pits, wherein the record power (Pw) is such a predetermined power that provides a substantially constant value (CF) of B/Pw², where “B” is the value obtained by sampling and holding an amount of reflected light upon irradiation of the laser light of the recording power (Pw).

The problems are also alleviated by an optical disk apparatus for recording information by irradiating laser light onto an optical disk at a predetermined record power (Pw) to form record pits, which apparatus includes a laser for emitting laser light of a predetermined recording power (Pw), a laser control unit for control of an output of the laser, a sample/hold unit for obtaining a sample/hold value (B) of a reflection light amount upon formation of a record pit, wherein the laser control unit controls the record power (Pw) so that the value (CF) of B/Pw² becomes a substantially constant value.

According to the arrangement and control scheme of the invention, it is possible to accurately detect a recording state by means of reflected light during recording. Controlling the record power thereby makes it possible to realize well-stabilized recording pit formation. Thus it is possible to provide an optical disk apparatus which achieves recording with high quality.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing, in block form, a configuration of an optical disk apparatus in accordance with a first embodiment of the present invention.

FIGS. 2A to 2D are graphs showing effects of this invention.

FIG. 3 is a flow chart of an operation control procedure of the first embodiment.

FIG. 4 is a block diagram showing one embodiment of a B-level acquisition unit.

FIG. 5 is a block diagram showing one embodiment of a CF calculation unit.

FIG. 6 is a block diagram showing one embodiment of a record power control unit.

FIG. 7 is a block diagram showing a configuration of an optical disk apparatus in accordance with a second embodiment of the invention.

FIG. 8 is a block diagram showing a CF calculator unit used in the second embodiment.

FIG. 9 is a flowchart of an operation control routine of the second embodiment.

FIGS. 10A and 10B are diagram each showing a reflection light waveform during recording.

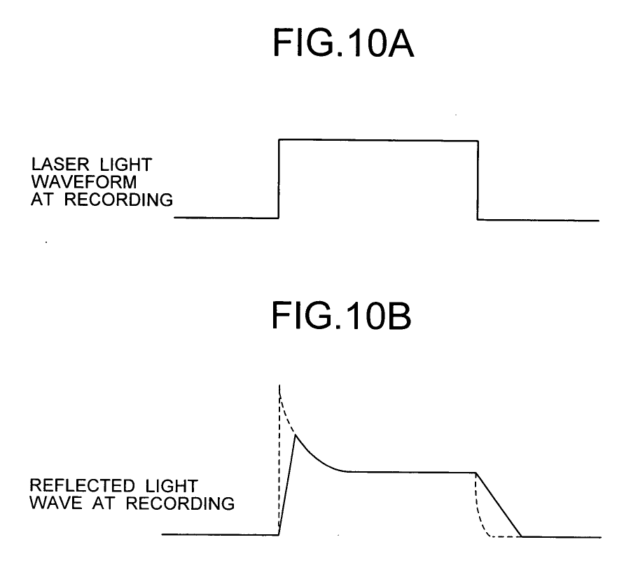

### DESCRIPTION OF THE EMBODIMENTS

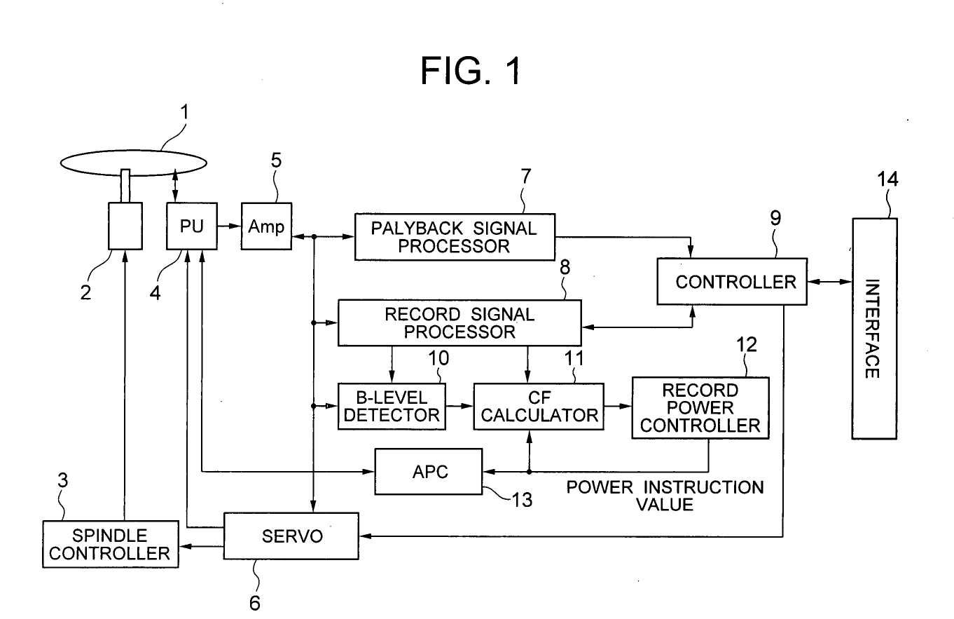

FIG. 1 is a block diagram of an optical recording apparatus of a first embodiment. In FIG. 1, reference numeral “1” designates an optical disk (or disc). Numeral 2 denotes a spindle motor; 3 indicates a spindle motor control unit for control of the rotation number of the spindle motor 3; 4 is an optical pickup module for irradiation of laser light; 5, an amplifier for amplifying reflected light from the optical disk 1; 6, a servo unit; 7, a reproduction or “playback” signal processing unit; 8, a record signal processing unit; 9, a controller; 10, a B-level detection unit for detecting an almost stable value (referred to as “B level” hereinafter) from an output of the amplifier 5; 11, a CF calculating unit for determining by arithmetic computation the value of a control factor (“CF”); 12, a record power control unit; 13, an auto-power control (APC) unit which stabilizes the record power at a predetermined value; and, 14, an interface.

An exemplary recording operation will be explained below. During the recording operation, the controller 9 receives an information record command from the outside through the interface 14. The record signal processing unit 8 receives information to be recorded, which is externally input via the interface 14 in response to an instruction from the controller 9, and then applies thereto coding and modulating processing to thereby generate record data. Thereafter, it outputs to the optical pickup 4 a control signal for control of the laser power and the waveform of light being emitted. The optical pickup 4 irradiates a beam of recording laser light based on the control signal, thus recording the information on the optical disk 1. During this recording operation, the optical pickup 4 also operates to detect light reflected from the optical disk 1 and then supplies a reproduction or “playback” signal to the servo unit 6 and playback signal processing unit 7 by way of the amplifier 5.

At the playback signal processing unit 7, this processor extracts from the playback signal a push-pull signal, for example, to thereby detect the irradiation position of the laser light on the optical disk 1 and then output a detection signal to the controller 9. The controller 9 supplies the servo unit 6 with information on the above-noted irradiation position. The servo unit 6 uses the irradiation position information and the playback signal to control the position of the optical pickup 4 so that the laser light irradiates the disk surface at a desired position. The servo unit 6 also detects from the playback signal a rotation number of the optical disk and then controls the spindle motor 2 by using the spindle motor control unit 3 so that the rotation number attains a desired value.

The power of the recording light being emitted from the optical pickup 4 is monitored by a front-end monitor (not shown 1) which is provided within the optical pickup 4, whereby a front monitor value based on the record power is supplied to the APC unit 13. The APC unit 13 compares this front monitor value with a power indication value supplied from the record power control unit 12. If the record power is less than the power indication value, then the APC unit 13 instructs the optical pickup 4 to increase the record power. If the record power is greater than the power indication value then APC unit 13 instructs optical pickup 4 to decrease the record power. In this way, control is done so that the record power of light being emitted from optical pickup 4 stays equal in value to the power indication value. With the operation above, it becomes possible to irradiate laser light with a desired record power at a desired surface position of the optical disk 1, thereby enabling formation of a train of record pits.

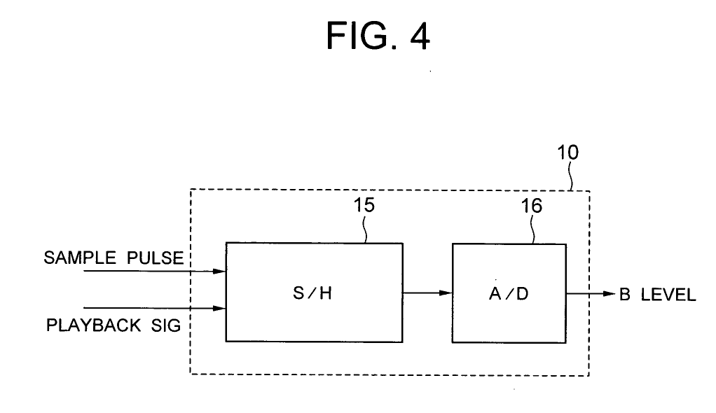

One example of the B level detection unit 10 is shown in FIG. 4. In FIG. 4, numeral “15” denotes a sample-and-hold unit whereas 16 indicates an analog-to-digital (A/D) converter. To the B level detector 10, a playback signal that is reflection light during recording is supplied from the amplifier 5. A sample pulse signal is also supplied to B level detector 10 from the record signal processor 8, for enabling sample-and-hold at a timing synchronized with the record signal. Whereby, it is possible to sample and hold a substantially stabilized level of the playback signal that is the reflected light during the pit formation. The resulting sample/hold signal is then converted by the A/D converter 16 into a digital signal, which becomes an output of the B level detector 10 as a digital value indicating the B level that is a substantially stable value.

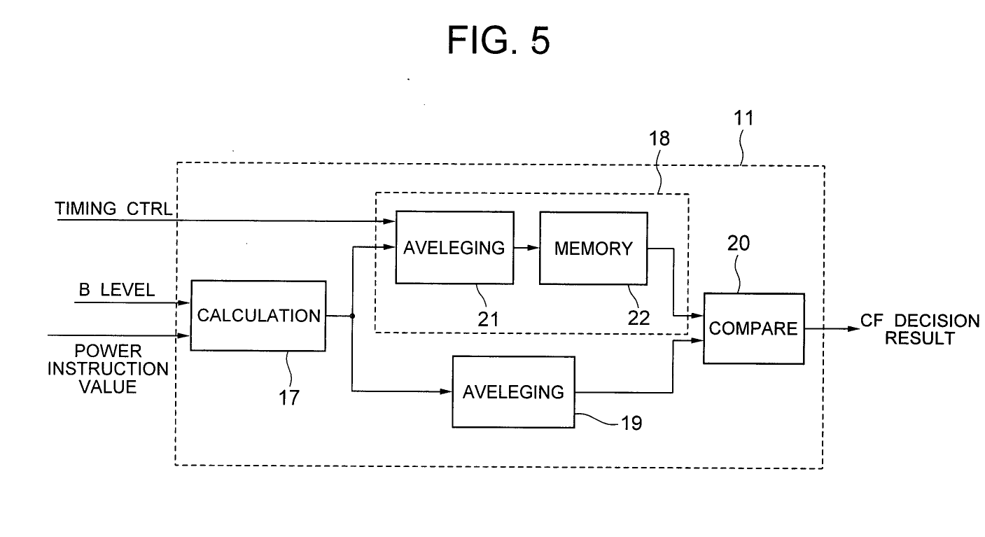

An example of the CF processing unit 11 is shown in FIG. 5. In FIG. 5, numeral 17 denotes an arithmetic processor; 18 indicates a reference value acquisition unit; 19 is an averaging unit; 20, a comparator. The reference value acquisition unit 18 includes a reference value averaging unit 21 and a storage unit 22, such as a memory. First, the CF processor 11 generates a CF value by making a calculation between a B level inputted thereto and a power indication value inputted from the record power control unit 12. Next, at the time of acquiring a reference value, the CF value is input to the reference value acquisition unit 18 so that the reference value averaging unit 21 calculates an average value for a prescribed time period, based on a timing signal that is input from the record signal processor 8. Here, when the average value for the specified time period is obtained, this is input and stored in the memory 22 as a CF reference value.

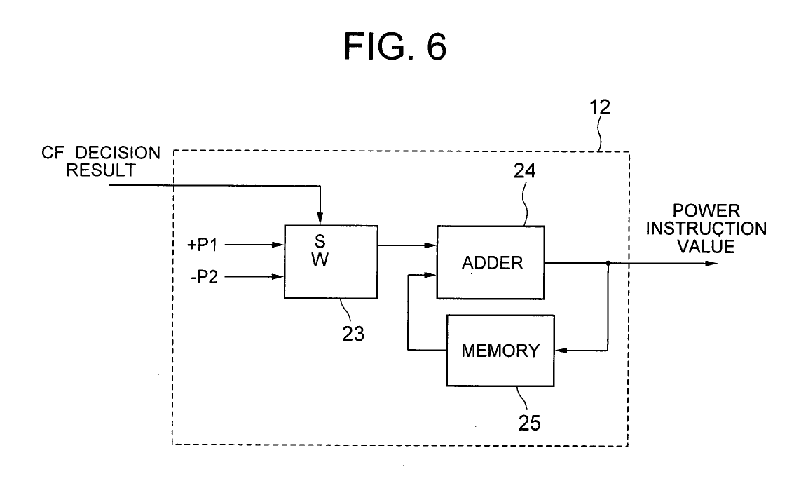

An example of the record power control unit 12 is shown in FIG. 6. In FIG. 6, numeral 23 indicates a switch; 24 is an adder; 25, a storage unit, such as a memory.

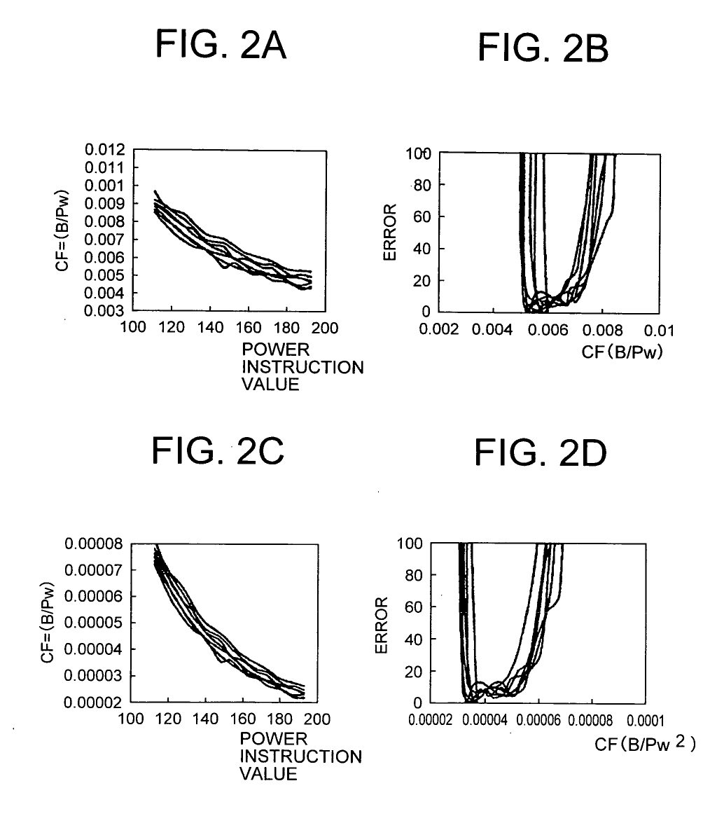

An explanation will next be given of a control method of the record power for performing recording with increased stability with reference to FIGS. 2A to 2D. FIGS. 2A-2D are graphs plotting measurement results in case recording is done on DVD−R disks at a recording rate of about 104 Mbps, which is equivalent to a four-time (×4) write speed. FIG. 2A shows changes of the CF value according to Equation (1) below in case the power is rendered variable. FIG. 2B shows the number of playback errors with respect to the CF value according to Equation (1). FIG. 2C shows changes in CF value according to Equation (2) in case the power is varied. FIG. 2D shows the number of playback errors for the CF value according to Equation (2). Although seven curves are plotted in each graph, this is for indication of the results of data taken at different radial positions. As described previously, disks of the type using dye films are such that the recording sensitivity is different relative to a radial direction of a disk. In view of this sensitivity variability, it is appropriate to perform data acquisition at a plurality of radial positions. Note that these measurements are done at intervals of about 5 millimeters (mm).
CF=(B level/Pw) Eq. (1)
CF=(B level/Pw²) Eq. (2)

A technique for obtaining respective curves in each graph will be explained. First, perform recording at a predetermined radius position of a disk with the power instruction value from the record power control unit 12 being changed and a B level is measured for each power instruction value. Then, substitute the power instruction value Pw corresponding to the measured B level into Equations (1) and (2) and calculate each CF value. The graphs shown in FIGS. 2A and 2C are thus obtained in this way.

Then, perform reproduction or playback of the data stored in a recorded disk surface area and perform measurement of a number of playback errors for a predetermined time period. The graphs of FIGS. 2C and 2D have been obtained in this way. Note here that the playback error number is a PI error number in a one error code correction (LECC) block. In the case of all errors, the error number becomes equal to 208.

Below is an explanation of characteristics of the graph in each diagram. First, an explanation will be given of the controllability for the power instruction value. In the case of employing the CF value of Equation (1), when letting the power instruction value change from 120 up to 180, the CF value changes from about 0.008 to about 0.005 as shown in FIG. 2A. This is equivalent to the CF value's decrease to about 62%. On the other hand, in the case of using the CF of Equation (2), when letting the power indication value change from 120 to 180, the CF value varies from about 0.00007 to about 0.00003 as shown in FIG. 2C. This is equal to the CF value's decrease to about 43%. In other words, it can be said that the rate of decrease of the CF value in the case of using Equation (2) is higher than the decrease rate in the case of using Equation (1), and that the control sensitivity for a CF value change is high. This in turn indicates that more precise controllability is achievable when providing control by use of Equation (2).

Next, let us compare changes in the error for the CF value. Suppose that an allowable error value is less than or equal to 20. As shown in FIG. 2B, in the case of employing the CF value of Equation (1), large deviations are found among the curves corresponding to respective radial positions. Thus, in order to suppress the error number to stay less than or equal to the allowable value at any radial position, it is necessary to control the CF value so that it stays within a range of from about 0.006 to 0.0065. In short, the CF value needs to be controlled to be 0.00625±4%. In contrast, in the case of using the CF value of Equation (2), variations among the curves corresponding to respective radial positions is less as shown in FIG. 2D. Thus, in order to suppress the error number to stay less than or equal to the allowable value at any radial position, the CF value needs to be controlled to be within the range from about 0.000035 to 0.00005. In short, it suffices that the CF value be controlled to be 0.0000425±17%.

As apparent from the above results, the CF value obtained using Equation (2) is preferable from a viewpoint of the control sensitivity also. In regard to a control margin, the CF given by Equation (2) is wider than that of Equation (1). Thus, controlling using Equation (2) makes it possible to realize well-stabilized operations while at the same time providing stability-enhanced recording quality over the entire disk surface area. More specifically, it becomes possible to establish a desired level of record quality by controlling the Pw value so that Pw=(B level/constant)^{1/2}.

An explanation will next be given of a technique for acquiring the CF reference value. This reference value is obtainable by averaging those CF values that are obtained during a predetermined time period when starting recording. With this scheme, it is possible to reduce recording errors otherwise occurring due to possible decentering or deviation of the center of a disk and the influence due to sensitivity irregularities along the circumference of a disk. In this method also, it is possible to acquire a well-stabilized value because the use of the CF value of Equation (2) results in achievement of wide control margins.

By using the CF value given by Equation (2) for the control, it becomes easy, as also shown in FIGS. 2C-2D, to control the CF value so as to increase the CF value (i.e., lowering the power instruction value) when the CF value is less than the reference value and decrease the CF value(i.e., raising the power instruction value) when the CF value is larger than the reference value. Thus, appropriate power control is achievable, thereby enabling accomplishment of well-stabilized recording.

Furthermore, as shown in FIG. 2D, when the CF value becomes smaller, errors increase rapidly. This possibly leads to a risk that the resulting error number fails to stay less than or equal to the allowable value in cases where the CF control is being done at around the lower critical level or lower limit of a proper CF value. This problem may be eliminated, when the CF value is less than the reference value, by making the control amount of a power instruction value larger than that in the-case where the CF value is larger than the reference value. As a result of this, control errors of the CF value behave to concentrate on the larger side relative to the reference value. Thus it is possible to avoid the CF value control from taking place in the vicinity of a region in which errors increase rapidly. This makes it possible to realize recording with further increased stability.

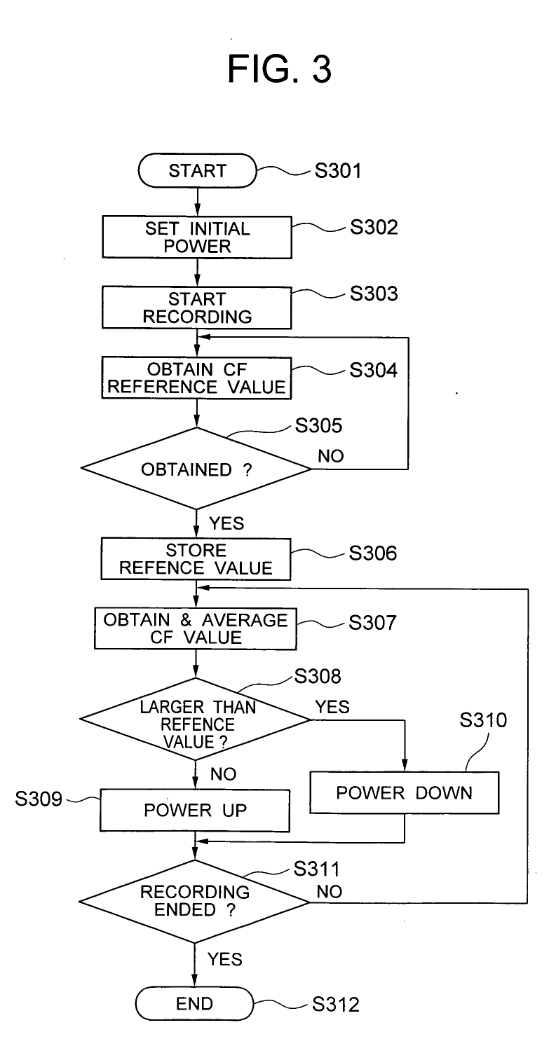

A power control procedure during a recording operation of the apparatus in the embodiment of FIG. 1 will be explained with reference to a flowchart of FIG. 3.

Firstly at step S302, the initial power is set up upon start-up of recording. Typically, the initial power is determined by execution of power adjustment in a trial write area which is present at an inner circumference of a disk, although the initial power setup method is not limited thereto.

Next, for a prescribed time period after the startup of recording (at step S303), acquisition and averaging of CF reference values are performed, which values are then stored (at steps S304 to S306). At this time, at the B level detector 10, a B level is detected which is an almost stable value, while CF processing is done at the CF calculator 11 to acquire the average value thus obtained.

An explanation will next be given of an operation during recording after the reference value acquisition. After having acquired the reference value, acquisition of a CF value is performed (at step S307). In case the CF value thus obtained is larger than the reference value, the power instruction value is made smaller, thereby reducing the recording power (at step S310). If the CF value obtained is less than the reference value then the power instruction value is made larger to thereby increase the record power (step S309). The operation above will be repeatedly continued until termination of the recording (step S312), thereby making it possible to enhance the stabilization of the recording quality.

This operation is performed by the CF processing unit 11 and record power control unit 12. The CF processing unit 11 is arranged such that in the configuration of FIG. 5, an output of the arithmetic processor 17 is averaged by the averaging unit 19 for a specified length of time period, and is then supplied to the comparator 20 after removal of noise and variation components occurring due to circumferential irregularities. The comparator 20 operates to perform comparison between the CF average value from the averaging unit 19 during recording and the reference value from the storage unit 22 for determination of which one is larger or smaller than the other, and then outputs a CF decision result.

In contrast, in the record power control unit 12 shown in FIG. 6, the switch 23 switches the output between +P1 and −P2 in accordance with the CF decision result inputted thereto. More specifically, it outputs −P2 in case the CF value is determined to be less than the reference value in the CF decision result, and outputs +P1 when the CF value is determined to be larger than the reference value in the CF decision result. At the adder 24, an output of the storage unit 25 is added, resulting in generation of the power instruction value. This power indication value is stored in the storage unit 25, whereby the addition of P1 or the subtraction of P2 is performed with respect to its immediately preceding power instruction value in accordance with the CF decision result. Note that the setup of P1<P2 results in the CF value's control errors concentrating on the larger side relative to the reference value, thereby enabling achievement of recording with enhanced stability.

With the arrangement and operation stated above, it is possible to realize the record power control scheme with CF=(B level/Pw²). This in turn makes it possible to provide the intended optical disk apparatus capable of achieving well-stabilized recording quality.

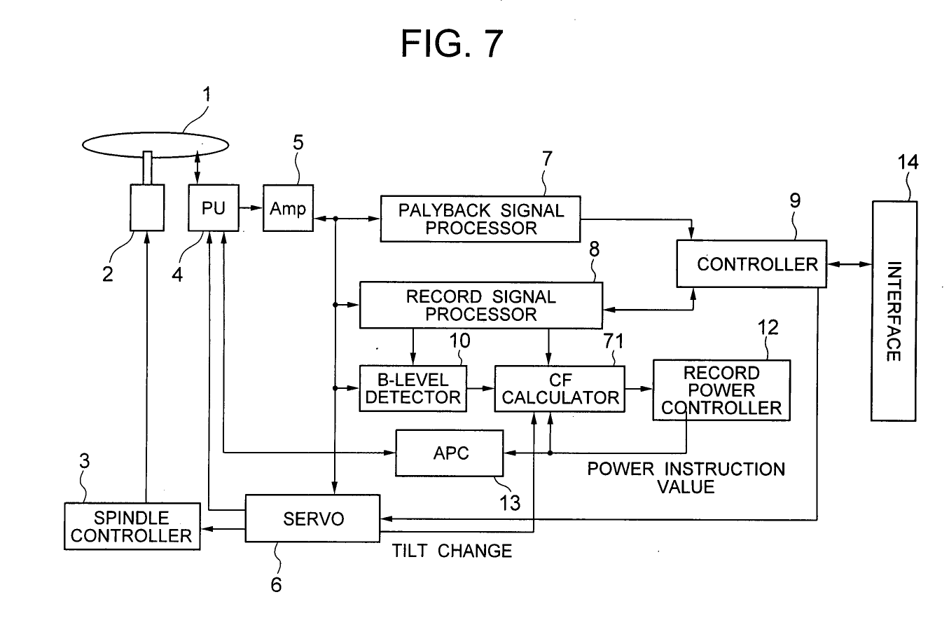

Next, a second embodiment of this invention will be explained. This embodiment shown in FIG. 7 is an embodiment directed to the case of controlling a tilt angle between a beam of recording laser light and an optical disk during recording. Note that those parts or components which are the same as those shown in FIG. 1 are denoted by the same reference numerals. Since the basic operation thereof is the same as that stated supra, a detailed explanation is eliminated herein. A difference of the second embodiment from the first embodiment lies in that the former has in its optical pickup 4 a tilt adjustment mechanism for changing the tilt angle between the optical disk and the record (write) laser light so that the tilt adjustment angle may be changed in response to a control signal from the servo unit 6. To reflect this control signal on the CF value calculation, this embodiment is arranged to use a CF calculator unit 71.

The tilt angle between the optical disk and the record laser light can deviate relative to that during normal operations. If such takes place, a spot shape of the record laser light being focussed onto the optical disk will change, resulting in a change in the state of formation of a record pit. Accordingly, for the record pit formation, it is important to optimally control the tilt angle between the optical disk and record laser light and, since the change in the state of the record pit formation also means a change in the level of reflected light, it becomes necessary to control the record power correspondingly to such change.

In this embodiment, when the tilt angle control is done by the servo unit 6, a tilt change signal is supplied to the CF calculator unit 71.

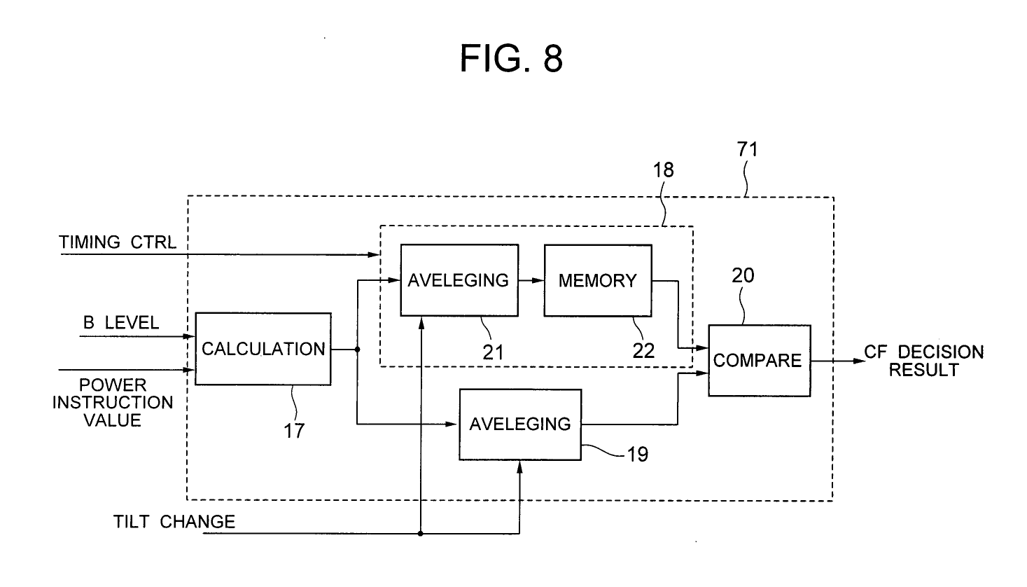

One example of the CF calculator unit 71 of this embodiment is shown in FIG. 8. Note that in FIG. 8, the same elements as those of FIG. 5 are added the same numerals. As its principal operation is the same as that of the CF calculating unit 11 shown in FIG. 5, its detailed explanation is omitted herein. It is arranged such that when the tilt change signal is input to the CF calculator unit 71 of FIG. 8, the averaging at the reference value averaging unit 21 and averaging unit 19 is reset, permitting starting of a new averaging. This is because re-execution of averaging is required since the level of a playback signal during recording changes when the tilt changes.

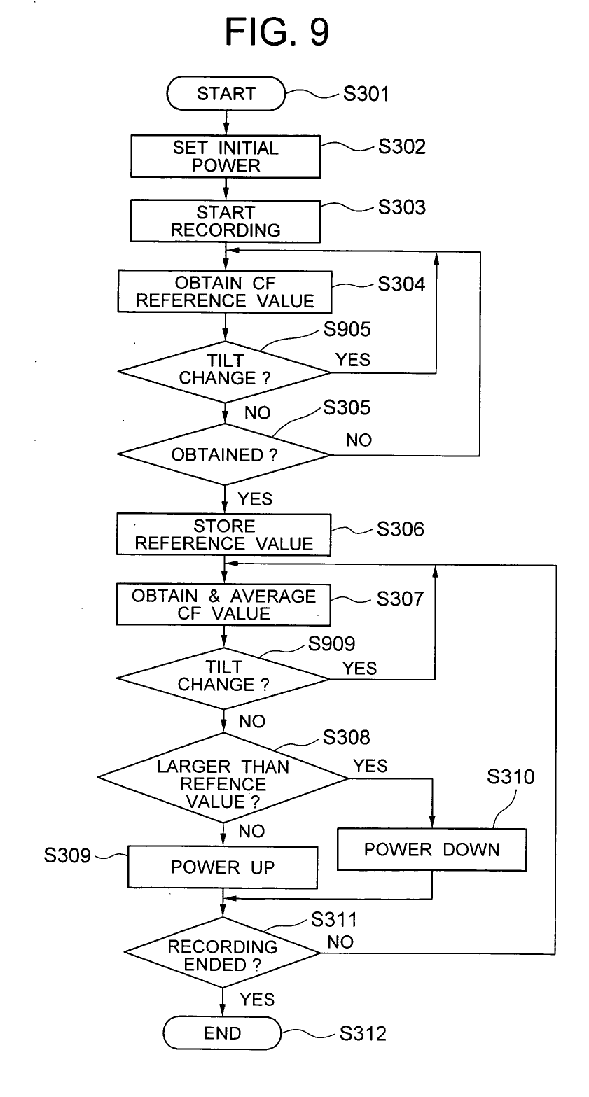

A flow chart of this operation is shown in FIG. 9. A control routine of FIG. 9 is the same in basic operation as that shown in FIG. 3 so that a detailed description is eliminated. As shown in FIG. 9, when the tilt angle is changed during acquisition of the CF reference value (step S905), the measurement and calculation results are all reset, followed by an operation of producing a new CF reference value.

Further, when a tilt change is found during acquisition of the CF average value during recording also (step S909), the measurement/calculation results are reset, followed by an operation of reproducing a new CF average value. With the operations, it is possible to preclude record-pit formation defects otherwise occurring due to a change in tilt angle between an optical disk and record laser light, and also to realize a power control adapted to disk characteristics. Thus it becomes possible to provide the intended optical disk apparatus with further enhanced stability of recording quality.

It should be further understood by those skilled in the art that although the foregoing description has been made on embodiments of the invention, the invention is not limited thereto and various changes and modifications may be made without departing from the spirit of the invention and the scope of the appended claims.

1. A method for recording information by irradiating laser light onto an optical disk at a record power Pw to form record pits, wherein the record power Pw is increased by a first change amount or the record power Pw is decreased by a second change amount so as to satisfy an equation,
Pw=(B/constant number)^{1/2},
where B is a reflection light amount upon irradiation of laser light.

2. The method according to claim 1, wherein said second change amount is greater than said first change amount.

3. A method for recording information by irradiating laser light onto an optical disk at a predetermined record power (Pw) to form record pits, wherein when letting a control index number or control factor CF be given as B/Pw², where Pw is a record power, and B is a reflection light amount upon irradiation of the laser light, said method comprising the steps of:
controlling the record power so as to be increased by a first change amount when a CF average value that is obtained by averaging the CF during recording for a predetermined length of time period is greater than a specified reference value; and
controlling the record power so as to be decreased by a second change amount when the CF average value that is obtained by averaging the CF during recording for a predetermined length of time period is less than the specified reference value and recording information.

4. The method according to claim 3, wherein said reference value is obtained by acquiring CFs at a plurality of radial positions of the optical disk upon start of recording and then averaging the plurality of CFs.

5. The method according to claim 3, wherein said CF average value during recording is reset when said optical disk changes in tilt.

6. The method according to claim 3, wherein said second change amount is larger than said first change amount.

7. An optical disk apparatus for recording information by irradiating laser light onto an optical disk at a predetermined record power (Pw) to form record pits, said apparatus comprising:
a laser which irradiates a laser light of a predetermined record power (Pw);
sample/hold means for obtaining a sample/hold value (B) of a reflection light amount when forming a record pit;
laser control means for controlling the record power (Pw) of said laser so that a value (CF) of B/Pw² is substantially constant;
storage means for storing a reference value which is obtained by acquiring a plurality of CF values at radial positions of a optical disk when starting recording and then averaging the plurality of CF values; and
comparison means for comparing the reference value stored in said storage means with a CF average value obtained by averaging CF values during recording for a predetermined length of time period, wherein
said laser control means increases the record power by a first change amount when said CF average value is larger than said reference value, and decreases the record power by a second change amount when said CF average value is less than said reference value.

8. The apparatus according to claim 7, further comprising:
tilt detection means for detecting a tilt of said optical disk, wherein said CF average value is reset when the tilt of said optical disk is changed.

9. The apparatus according to claim 7, wherein said second change amount is larger than said first change amount.

10. An optical disk apparatus for recording information by irradiating laser light onto an optical disk at a predetermined record power (Pw) to form record pits, said apparatus comprising:
a laser which irradiates a laser light of a predetermined record power (Pw);
a sample/hold unit which obtains a sample/hold value (B) of a reflection light amount when forming a record pit;
a laser control unit which controls the record power (Pw) of said laser so that a value (CF) of B/Pw² is substantially constant;
a storage which stores a reference value which is obtained by acquiring a plurality of CF values at radial positions of a optical disk when starting recording and then averaging the plurality of CF values; and
a comparison unit which compares the reference value stored in said storage means with a CF average value obtained by averaging CF values during recording for a predetermined length of time period, wherein
said laser control unit increases the record power by a first change amount when said CF average value is larger than said reference value, and decreases the record power by a second change amount when said CF average value is less than said reference value.

11. The apparatus according to claim 10, further comprising:
a tilt detection unit which detects a tilt of said optical disk, wherein said CF average value is reset when the tilt of said optical disk is changed.

12. The apparatus according to claim 10, wherein said second change amount is larger than said first change amount.
